(19) United States
(12) Patent Application Publication
(10) Pub. No.: US 2023/0406763 A1
(43) Pub. Date: Dec. 21, 2023

(54) CHEMICALLY-STRENGTHENED GLASS CONTAINING GLASS CERAMIC, AND METHOD FOR MANUFACTURING SAME

(71) Applicant: AGC Inc., Tokyo (JP)

(72) Inventors: Takumi UMADA, Chiyoda-ku (JP); Qing LI, Chiyoda-ku (JP); Shunji WACHI, Chiyoda-ku (JP)

(73) Assignee: AGC Inc., Tokyo (JP)

(21) Appl. No.: 18/461,121

(22) Filed: Sep. 5, 2023

Related U.S. Application Data
(63) Continuation of application No. PCT/JP2022/014980, filed on Mar. 28, 2022.

(30) Foreign Application Priority Data
Apr. 7, 2021 (JP) 2021-065435

(51) Int. Cl. C03C 21/00; C03C 23/00; C03C 10/00; C03C 3/097

(52) U.S. Cl. CPC C03C 21/002; C03C 23/0075; C03C 10/0027; C03C 3/097

(57) ABSTRACT

The present invention relates to a chemically-strengthened glass having a first main surface and a second main surface, including a glass ceramic including a crystal and a residual glass, having a surface compressive stress value (CS₀) of 450 MPa or more, and a compressive stress value (CS₅₀) at a depth of 50 μm of 150 MPa or more, having a plurality of non-through holes having a diameter average value of 5 nm to 50 nm on the first main surface and the second main surface, the non-through holes having a depth average value measured by a cross-sectional SEM image of the first main surface and the second main surface of 5 nm to 50 nm, and having a total area ratio to a total visual field area of a surface SEM image of the first main surface and the second main surface of 1% to 40%.

### CROSS-REFERENCE TO RELATED APPLICATIONS

This is a continuation of International Application No. PCT/JP2022/014980 filed on Mar. 28, 2022, and claims priority from Japanese Patent Application No. 2021-065435 filed on Apr. 7, 2021, the entire content of which is incorporated herein by reference.

### TECHNICAL FIELD

The present invention relates to chemically-strengthened glass ceramic and a method for producing the same.

### BACKGROUND ART

Chemically-strengthened glass is used for cover glass or the like of a mobile terminal. The chemically-strengthened glass is obtained, for example, by bringing glass into contact with a molten salt containing an alkali metal ion to cause ion exchange between an alkali metal ion in the glass and the alkali metal ion in the molten salt, thereby forming a compressive stress layer on a glass surface.

As a base material of such chemically-strengthened glass, amorphous glass containing Li₂O or glass ceramic containing Li₂O is particularly excellent. A reason is that a compressive stress is easily formed up to a deep portion in the chemically-strengthened glass by ion exchange between a lithium ion contained in the base material and a sodium ion contained in a strengthening salt. Since the lithium ion and the sodium ion have relatively small ionic radius, a diffusion coefficient by ion exchange is large. In addition, the amorphous glass and the glass ceramic containing Li₂O have relatively large fracture toughness values and tend to be resistant to cracking.

The glass ceramic is glass in which crystals are precipitated, and is harder and less likely to be damaged than amorphous glass containing no crystals. In addition, the glass ceramic capable of being chemically strengthened can have high strength while preventing fracturing as compared with amorphous glass. However, glass ceramic often has insufficient transparency compared to amorphous glass.

Patent Literatures 1 and 2 describe examples in which glass ceramic is subjected to ion exchange treatment to be chemically strengthened.

### CITATION LIST

### Patent Literature

Patent Literature 1: WO2019/022035
Patent Literature 2: U.S. Patent Application Publication No. 2020/0017398

### SUMMARY OF INVENTION

### Technical Problem

The chemically-strengthened glass containing the glass ceramic described in Patent Literatures 1 and 2 is excellent in transparency and chemical strengthening properties, but may have insufficient transparency.

Therefore, an object of the present invention is to provide chemically-strengthened glass containing glass ceramic, which is excellent in transparency and chemical strengthening properties.

### Solution to Problem

As a result of studies on the above problems, the present inventors have found that chemically-strengthened glass, which contains glass ceramic and in which a plurality of non-through holes are provided on both main surfaces, and a diameter average value, a depth average value, and a total area ratio of the non-through holes are within specific ranges, is excellent in transparency and chemical strengthening properties, and completed the present invention.

The present invention relates to a chemically-strengthened glass having a first main surface and a second main surface facing each other, in which
the chemically-strengthened glass includes a glass ceramic including a crystal and a residual glass,
the chemically-strengthened glass has a surface compressive stress value (CS₀) of 450 MPa or more, and a compressive stress value (CS₅₀) at a depth of 50 μm from a surface of the chemically-strengthened glass of 150 MPa or more,
the chemically-strengthened glass has a plurality of non-through holes having a diameter average value of 5 nm to 50 nm on the first main surface and the second main surface,
the non-through holes have a depth average value measured by a cross-sectional SEM image of the first main surface and the second main surface of 5 nm to 50 nm, and
the non-through holes have a total area ratio to a total visual field area of a surface SEM image of the first main surface and the second main surface of 1% to 40%.

In the present chemically-strengthened glass, Eg/Ec is preferably 0.1 to 0.0001, provided that Eg is an etching rate of the residual glass and Ec is an etching rate of the crystal.

In the present chemically-strengthened glass, a base composition preferably contains 40% to 70% of SiO₂, 5% to 35% of Li₂O, and 1% to 20% of Al₂O₃ in terms of mol % based on oxides.

In the present chemically-strengthened glass, a crystallization rate is preferably 10 mass % to 90 mass %.

In the present chemically-strengthened glass, the first main surface and the second main surface preferably have a reflectance of 10% or less.

In the present chemically-strengthened glass, a light transmittance in terms of a thickness of 700 μm before chemical strengthening is preferably 90% or more.

In the present chemically-strengthened glass, a sheet thickness is preferably 300 to 3,000 μm.

The present invention also relates to a method for producing a chemically-strengthened glass, the method including:
chemically strengthening a glass ceramic including a crystal and a residual glass to obtain a chemically-strengthened glass; and
washing a surface of the chemically-strengthened glass using a washing liquid having a pH of 2 to 12 after the chemical strengthening,
in which
the chemically-strengthened glass has a first main surface and a second main surface facing each other,
the chemically-strengthened glass has a surface compressive stress value (CS₀) of 450 MPa or more, and a compressive stress value (CS₅₀) at a depth of 50 μm from a surface of the chemically-strengthened glass of 150 MPa or more,
the chemically-strengthened glass has a plurality of non-through holes having a diameter average value of 5 nm to 50 nm on the first main surface and the second main surface,
the non-through holes have a depth average value measured by a cross-sectional SEM image of the first main surface and the second main surface of 5 nm to 50 nm, and
the non-through holes have a total area ratio to a total visual field area of a surface SEM image of the first main surface and the second main surface of 1% to 40%.

In the present method for producing a chemically-strengthened glass, Eg/Ec is preferably 0.1 to 0.0001, provided that Eg is an etching rate of the residual glass and Ec is an etching rate of the crystal.

In the present method for producing a chemically-strengthened glass, a base composition of the glass ceramic preferably contains 40% to 70% of SiO₂, 5% to 35% of Li₂O, and 1% to 20% of Al₂O₃ in terms of mol % based on oxides.

### Advantageous Effects of Invention

The chemically-strengthened glass according to the present invention is a glass ceramic in which a plurality of non-through holes are provided on both main surfaces, and a diameter average value, a depth average value, and a total area ratio of the non-through holes are within specific ranges, and thus can implement high chemical strengthening properties while exhibiting excellent transparency with a reduced reflectance.

### BRIEF DESCRIPTION OF DRAWINGS

FIG. 1A, FIG. 1B, and FIG. 1C are diagrams showing an example of a surface SEM image. FIG. 1A is a diagram showing an example of chemically-strengthened glass according to the present invention. FIG. 1B is a diagram showing an example of chemically-strengthened glass in the related art. FIG. 1C is an enlarged view of a portion surrounded by a dotted line in FIG. 1A.

FIG. 2 is a partial cross-sectional view conceptually showing a surface layer of one main surface in one embodiment of the present invention.

FIG. 3A and FIG. 3B are diagrams showing examples of a cross-sectional SEM image of the chemically-strengthened glass according to the present invention.

### DESCRIPTION OF EMBODIMENTS

In the present description, “to” indicating a numerical range is used in a meaning including numerical values described before and after the numerical range as a lower limit value and an upper limit value unless otherwise specified.

In the present description, “amorphous glass” refers to glass in which a diffraction peak indicating a crystal is not observed by a powder X-ray diffraction method to be described later. “Glass ceramic” is obtained by subjecting “amorphous glass” to heat treatment to precipitate crystals, and contains crystals. In the present description, “amorphous glass” and “glass ceramic” may be collectively referred to as “glass”. In addition, the amorphous glass that becomes glass ceramic by the heat treatment may be referred to as “base glass of glass ceramic”.

In the present description, in the powder X-ray diffraction measurement, for example, a range of 20 of 10° to 80° is measured using a CuKα ray, and in a case where a diffraction peak appears, precipitated crystals are identified by a Hanawalt method. In addition, a crystal identified from a peak group including a peak having the highest integrated intensity among the crystals identified by this method is defined as a main crystal. As a measurement device, for example, SmartLab manufactured by Rigaku Corporation may be used.

In the present description, “residual glass” refers to an amorphous portion that is not crystallized in glass ceramic.

In the present description, a diameter of each non-through hole in the chemically-strengthened glass is determined by the following method. The non-through holes on the surface of the chemically-strengthened glass are observed in a plan view from directly above each of a first main surface and a second main surface with a scanning electron microscope (SEM) to obtain a surface SEM image at a magnification of 100,000 times. From the obtained surface SEM image, a non-through hole and a matrix portion (portion where no non-through hole is formed) are distinguished, a major axis of each non-through hole is determined as a diameter, and a diameter average value which is an average value thereof is calculated.

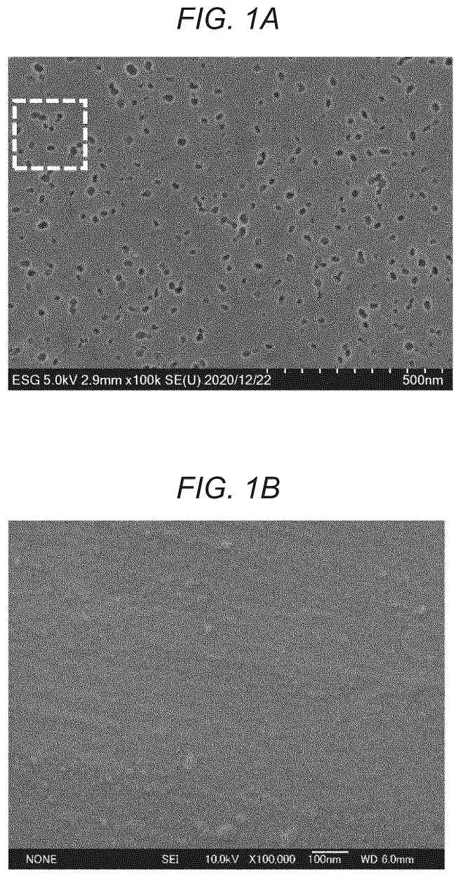

Specifically, for example, in FIG. 1A, a gray portion is a matrix portion in which no non-through hole is formed, and a black portion is a non-through hole. FIG. 1C is an enlarged view of a portion surrounded by a dotted line in FIG. 1A, and a length of a portion indicated by a white double-headed arrow is an example of the diameter of the non-through hole.

In the present description, a total area ratio of the non-through holes in the chemically-strengthened glass is determined by the following method. The surface of the chemically-strengthened glass is observed by SEM in a plan view to obtain a surface SEM image at a magnification of 100,000 times. From the obtained surface SEM image, non-through holes and matrix portions are distinguished, and a ratio of a total area of the non-through holes to a total visual field area of the surface SEM image is determined and defined as the total area ratio of the non-through holes.

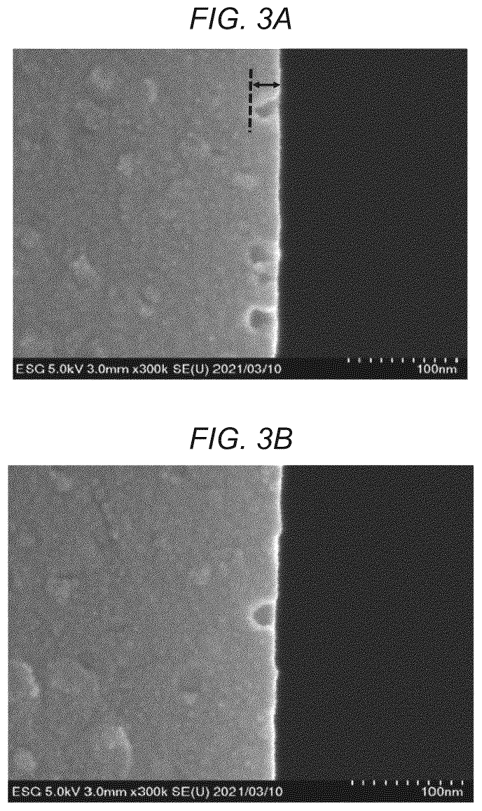

In the present description, a depth of the non-through hole is determined by the following method. A cross-sectional SEM image at a magnification of 300,000 times is obtained at a fractured surface of the chemically-strengthened glass. In the obtained cross-sectional SEM image, non-through holes and matrix portions are distinguished, a depth of each non-through hole is obtained, and a depth average value which is an average value of the depths is calculated. Specifically, in FIG. 3A, a length of a portion indicated by a black double-headed arrow is an example of the depth of the non-through hole.

In the present description, an “etching rate” (unit: nm/min) is obtained by measuring a weight loss (nm) per time (1 minute) of an etching treatment. Conditions for measuring an etching rate ratio are not particularly limited as long as a desired etching rate ratio can be obtained, and specific examples thereof generally include conditions of pH 2 to 12 and room temperature (15° C.) to 100° C. In addition, an etching solution used for the etching treatment is not particularly limited, and specific examples thereof include NaOH and HCl.

In the following, the “chemically-strengthened glass” refers to glass after being subjected to chemical strengthening treatment, and the “glass for chemical strengthening” refers to glass before being subjected to chemical strengthening treatment.

In the present description, a glass composition is represented in terms of mol % based on oxides unless otherwise specified, and mol % is simply referred to as “%”.

In addition, in the present description, “substantially not contain” means that a content is equal to or lower than an impurity level contained in a raw material or the like, that is, the content is not intentionally added. Specifically, the content is less than 0.1%, for example.

In the present description, a “stress profile” represents a compressive stress value with a depth from the glass surface as a variable. In the stress profile, a tensile stress is represented as a negative compressive stress.

The “compressive stress value (CS)” can be measured by thinning a cross section of glass and analyzing the thinned sample with a birefringence imaging system. A birefringence index stress meter of the birefringence imaging system is a device for measuring a magnitude of retardation caused by a stress using a polarization microscope, a liquid crystal compensator, or the like, and for example, is a birefringence imaging system Abrio-IM manufactured by CRi.

In addition, measurement may be performed using scattered light photoelasticity. In this method, light is incident from the surface of the glass, and polarization of scattered light is analyzed to measure CS. Examples of a stress measuring instrument using the scattered light photoelasticity include a scattered light photoelasticity stress meter SLP-2000 manufactured by Orihara Industrial co., ltd.

In the present description, a “compressive stress layer depth (DOL)” is a depth at which the compressive stress value is zero. Hereinafter, a surface compressive stress value may be referred to as CS₀, and a compressive stress value at a depth of 50 μm may be referred to as CS₅₀. In addition, an “internal tensile stress (CT)” refers to a tensile stress value at a depth of ½ of a sheet thickness t, and is equivalent to “CS_{t/2}” in the present description.

In the present description, a “light transmittance” refers to an average transmittance of light having a wavelength of 380 nm to 780 nm. In addition, a “haze value” is measured in accordance with JIS K7136:2000 using a halogen lamp C light source.

In the present description, a “reflectance” is defined based on JIS Z8701 (1999). A D₆₅ light source is used as the light source.

In the present description, a “fracture toughness value” is a value according to an IF method defined in JIS R1607:2015.

In the present description, a “drop strength” is measured by the following method.

A glass sample of 120×60×0.6 mmt is fitted into a structure whose mass and rigidity are adjusted to a size of a general smartphone to prepare a pseudo smartphone, and is freely dropped on #180 SiC sandpaper. A drop height is measured by repeating an operation that in a case where the glass sample is dropped from a height of 5 cm and is not cracked, raising the height by 5 cm and dropping the sample again until the glass sample is cracked, and measuring an average value of heights of 10 samples at the time of being cracked for the first time.

<Chemically-Strengthened Glass>

The chemically-strengthened glass according to the present invention (hereinafter also referred to as “present chemically-strengthened glass”) is typically a sheet-shaped glass article, and may be in a flat sheet or a curved surface. In addition, there may be portions having different thicknesses.

A thickness (t) in a case where the present chemically-strengthened glass is in a sheet shape is preferably 3,000 μm or less, and more preferably 2,000 μm or less, 1,600 μm or less, 1,100 μm or less, 900 μm or less, 800 μm or less, and 700 μm or less in a stepwise manner. In addition, in order to obtain sufficient strength by the chemical strengthening treatment, the thickness (t) is preferably 300 μm or more, more preferably 400 μm or more, and still more preferably 500 μm or more.

The surface compressive stress value (CS₀) of the present chemically-strengthened glass is preferably 450 MPa or more because the chemically-strengthened glass hardly cracks due to deformation such as deflection. CS₀ is more preferably 500 MPa or more, and still more preferably 600 MPa or more. The larger the CS₀, the higher the strength, but in a case of being too large, severe fracture may occur at the time of cracking, and thus the CS₀ is preferably 1,100 MPa or less, and more preferably 900 MPa or less.

The compressive stress value (CS₅₀) at a depth of 50 μm from the surface of the present chemically-strengthened glass is preferably 150 MPa or more because cracking of the present chemically-strengthened glass is easily prevented when a mobile terminal or the like including the present chemically-strengthened glass as cover glass is dropped. CS₅₀ is more preferably 180 MPa or more, and still more preferably 200 MPa or more. The larger the CS₅₀, the higher the strength, but in a case of being too large, severe fracture may occur at the time of cracking, and thus the CS₅₀ is preferably 300 MPa or lower, and more preferably 270 MPa or lower.

DOL of the present chemically-strengthened glass is preferably 90 μm or more because in a case of being 90 μm or more, cracking hardly occur even when the surface is scratched. DOL is more preferably 95 μm or more, still more preferably 100 μm or more, and particularly preferably 110 μm or more. The larger the DOL is, the more difficult it is to crack even if a scratch occurs, but as a tensile stress generates in the chemically-strengthened glass in accordance with a compressive stress formed in the vicinity of the surface, DOL cannot be extremely increased. In the case of the thickness t, DOL is preferably t/4 or less, and more preferably t/5 or less. In order to shorten the time required for chemical strengthening, DOL is preferably 200 μm or less, and more preferably 180 μm or less.

In a case where the sheet thickness is defined as t, the compressive stress value CS_{t/2} at the depth t/2 from the surface of the present chemically-strengthened glass is preferably −120 MPa or more, more preferably −115 MPa or more, and still more preferably −110 MPa or more. In a case where CS_{t/2} is −120 MPa or more, explosive cracking when the glass is scratched can be prevented. In addition, an upper limit of CS_{t/2} is not particularly limited, but is preferably −80 MPa or less for example, in order to maintain a sufficient compressive stress.

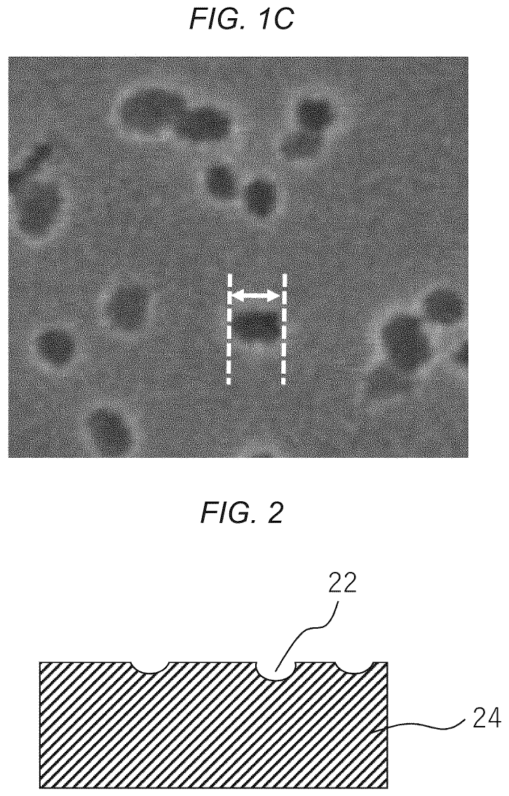

In the present chemically-strengthened glass, a plurality of non-through holes are observed when the first main surface and the second main surface are observed from directly above by the above-described method. FIG. 2 is a partial cross-sectional view conceptually showing an example of one main surface. As shown in FIG. 2, chemically-strengthened glass 24 includes non-through holes 22, so that irregularities are formed on the surface of the chemically-strengthened glass containing glass ceramic, the area ratio of the residual glass on the main surface of the chemically-strengthened glass is increased by the irregularities, the refractive index is decreased, thereby reducing the reflection on the surface of the chemically-strengthened glass, and thus the transmittance is improved.

The diameter average value of the non-through holes is preferably 5 nm to 50 nm, more preferably 8 nm to 40 nm, and still more preferably 10 nm to 30 nm. That is, the diameter average value of the non-through holes is preferably 5 nm or more, more preferably 8 nm or more, and still more preferably 10 nm or more. In addition, the diameter average value of the non-through holes is preferably 50 nm or less, more preferably 40 nm or less, and still more preferably 30 nm or less. In a case where the diameter average value of the non-through holes is 5 nm or more, the reflectance on the main surface is reduced, and the transparency can be improved. In addition, in a case where the diameter average value of the non-through holes exceeds 50 nm, a depth of the hole approaches a wavelength of light, the scattering becomes large, and the transmittance decreases.

The depth average value of the non-through holes measured in the cross-sectional SEM image of the first main surface and the second main surface of the present chemically-strengthened glass is 5 nm to 50 nm, preferably 8 nm to 40 nm, and more preferably 10 nm to nm. That is, the depth average value of the non-through holes is preferably 5 nm or more, more preferably 8 nm or more, and still more preferably 10 nm or more. In addition, the depth average value of the non-through holes is preferably 50 nm or less, more preferably 40 nm or less, and still more preferably 30 nm or less. As the depth average value is deeper than 5 nm, the refractive index in the vicinity of the glass surface is effectively decreased, so that the reflectance is decreased and the transparency can be improved. On the other hand, in a case where the depth average value exceeds 50 nm, the depth average value of the non-through holes approaches the wavelength of light, the scattering becomes large, and the transmittance decreases. A shape of the non-through hole observed in the cross-sectional SEM image is not particularly limited, and examples thereof include a circular shape, a semicircular shape, and a rectangular shape.

The total area ratio of the non-through holes to the total visual field area of the surface SEM image is 1% to 40%, preferably 1% to 30%, and more preferably 2% to 20%. That is, the total area ratio of the non-through holes is preferably 1% or more, and more preferably 2% or more. In addition, the total area ratio of the non-through holes is preferably 40% or less, more preferably 30% or less, and still more preferably 20% or less. In a case where the total area ratio of the non-through holes is 1% or more, the area ratio of the glass on the main surface of the glass is increased, the reflectance is reduced, and the transparency can be improved. In a case where the total area ratio of the non-through holes exceeds 40%, scattering on the surface increases, and the transmittance decreases.

The distribution of the non-through holes on the first main surface and the second main surface of the present chemically-strengthened glass is not particularly limited, but is preferably uniform from the viewpoint of improving the transparency.

The reflectance of the first main surface and the second main surface of the present chemically-strengthened glass is preferably 10% or less, more preferably 9% or less, and still more preferably 8% or less. In a case where the reflectance of the first main surface and the second main surface is 10% or less, excellent transparency is exhibited. A lower limit of the reflectance is not particularly limited, but is typically 5% or more.

In a case where the thickness is 700 μm, the haze value of the present chemically-strengthened glass is preferably 1.0% or less, more preferably 0.8% or less, still more preferably 0.6% or less, particularly preferably 0.4% or less, and most preferably 0.2% or less. The haze value is preferably as small as possible, but is usually 0.01% or more.

The drop strength of the present chemically-strengthened glass that is measured by the above-described method is preferably 160 cm or more, more preferably 170 cm or more, and still more preferably 180 cm or more. In a case where the drop strength is 160 cm or more, it is easy to prevent cracking of the present chemically-strengthened glass when the mobile terminal or the like including the present chemically-strengthened glass as cover glass is dropped. An upper limit of the drop strength is not particularly limited, but is typically 300 cm or less.

<<Composition>>

A base composition of the present chemically-strengthened glass preferably contains SiO₂, Li₂O, and Al₂O₃. The base composition of the present chemically-strengthened glass more preferably contains, in terms of mol % based on oxides,
40% to 70% of SiO₂,
5% to 35% of Li₂O, and
1% to 20% of Al₂O₃.

In addition, 50% to 70% of SiO₂,
10% to 30% of Li₂O,
1% to 15% of Al₂O₃,
0% to 5% of P₂O₅,
0% to 8% of ZrO₂,
0% to 10% of MgO,
0% to 5% of Y₂O₃,
0% to 10% of B₂O₃,
0% to 5% of Na₂O,
0% to 5% of K₂O, and
0% to 2% of SnO₂ are more preferably contained.

Here, the “base composition of the chemically-strengthened glass” refers to a composition of the glass ceramic before chemical strengthening. The composition will be described later. The composition of the present chemically-strengthened glass as a whole has a composition similar to that of the glass ceramic before strengthening, except for a case where an extreme ion exchange treatment is performed. In particular, the composition of the deepest portion from the glass surface is the same as the composition of the glass ceramic before strengthening, except for the case where an extreme ion exchange treatment is performed.

<<Use>>

The present chemically-strengthened glass is also useful as cover glass used in an electronic device such as a mobile device such as a mobile phone or a smartphone. Further, it is also useful for cover glass of an electronic device such as a television, a personal computer, or a touch panel, an elevator wall surface, or a wall surface (full display) of architecture such as a house or a building, which is not intended to be carried. In addition, it is also useful for a building material such as window glass, a table top, an interior of an automatic vehicle, an aircraft, or the like, cover glass thereof, and a housing having a curved surface shape.

<Glass Ceramic>

The present chemically-strengthened glass is glass ceramic containing crystals and residual glass (hereinafter also referred to as present glass ceramic). Since the present chemically-strengthened glass is glass ceramic containing a crystal and residual glass, the crystals in a surface layer portion of the glass are eluted by the washing treatment to be described later to form non-through holes.

In a case where the etching rate of the residual glass is defined as Eg and the etching rate of the crystal is defined as Ec, Eg/Ec of the present glass ceramic is preferably 0.1 to 0.0001, more preferably 0.05 to 0.0005, and still more preferably 0.01 to 0.001. That is, Eg/Ec is preferably 0.0001 or more, more preferably 0.0005 or more, and still more preferably or more. In addition, Eg/Ec is preferably 0.1 or less, more preferably 0.05 or less, and still more preferably 0.01 or less. In a case where Eg/Ec is within a range of 0.1 to 0.0001, the crystals present on the surface of the glass ceramic are eluted, non-through holes are easily formed, and the transparency can be improved.

The present glass ceramic preferably contains at least one selected from a Li₃PO₄ crystal, a LiAlSi₄O₁₀ crystal, a Li₂Si₂O₅ crystal, and a Li₄SiO₄ crystal, and more preferably contains at least one selected from a Li₃PO₄ crystal, a LiAlSi₄O₁₀ crystal, and a Li₂Si₂O₅ crystal. The present glass ceramic may contain such a solid solution crystal. Since the etching rate of these crystals is relatively high, the crystals present on the surface of the glass ceramic are eluted by the washing treatment to be described later, non-through holes are easily generated, and the transparency can be improved.

The Li₃PO₄ crystal and the Li₄SiO₄ crystal have similar crystal structures, and thus may be difficult to be distinguished by powder X-ray diffraction measurement. That is, when powder X-ray diffraction is measured, diffraction peaks appear in the vicinity of 20=16.9°, 22.3°, 23.1°, and 33.9°. Since the crystal amount may be small or the crystal may be oriented, a peak having low intensity or a peak of a specific crystal plane may not be observed. In addition, in a case where both crystals are solid dissolved, a peak position may be shifted by 2θ of about 1°.

When the X-ray diffraction is measured in the range of 2θ=10° to 80°, the strongest diffraction peak of the present glass ceramic preferably appears at 22.3°±0.2° or 23.1°±0.2°.

In order to increase the mechanical strength, the crystallization rate of the present glass ceramic is preferably 10 mass % or more, more preferably 15 mass % or more, and still more preferably 20 mass % or more. In order to increase the transparency, the crystallization rate is preferably 90 mass % or less, more preferably 70 mass % or less, still more preferably mass % or less, and particularly preferably 50 mass % or less. The low crystallization rate is also excellent in that the glass is easily bent by heating.

In order to increase the strength, an average particle size of the precipitated crystals of the present glass ceramic is preferably 5 nm or more, and particularly preferably 10 nm or more. In order to increase the transparency, the average particle size is preferably 80 nm or less, more preferably 60 nm or less, still more preferably 50 nm or less, particularly preferably nm or less, and most preferably 30 nm or less. The average particle size of the precipitated crystals is determined from a transmission electron microscopic (TEM) image.

The thickness (t) in a case where the present glass ceramic has a sheet shape is preferably 3,000 μm or less, and more preferably 2,000 μm or less, 1,600 μm or less, 1,100 μm or less, 900 μm or less, 800 μm or less, or 700 μm or less in a stepwise manner. In addition, in order to obtain sufficient strength by the chemical strengthening treatment, the thickness (t) is preferably 300 μm or more, more preferably 400 μm or more, and still more preferably 500 μm or more.

The light transmittance of the present glass ceramic before chemical strengthening is preferably 85% or more in a case where the thickness is 700 μm, because when being used as cover glass of a portable display, a screen of the display can be easily seen. The light transmittance is more preferably 88% or more, still more preferably 90% or more, and particularly preferably 92% or more. The light transmittance is preferably as high as possible, but is usually 95% or less. In a case where the thickness is 700 μm, the light transmittance of 90% is equivalent to that of ordinary amorphous glass.

In a case where the thickness is 700 μm, the light transmittance of the present glass ceramic after chemical strengthening is preferably 88% or more, because when being used as cover glass of a portable display, a screen of the display can be easily seen. The light transmittance is more preferably 90% or more, still more preferably 91% or more, and particularly preferably 92% or more. The light transmittance is preferably as high as possible, but is usually 95% or less. In a case where the thickness is 700 μm, the light transmittance of 90% is equivalent to that of ordinary amorphous glass.

In a case where the actual thickness is not 700 μm, the light transmittance in the case of 700 μm can be calculated from the Lambert-Beer law based on the measured value.

In a case where the total visible light transmittance of the present glass having a thickness t [μm] is 100×T [%] and a surface reflectance of one side is 100×R [%], T=(1−R)²×exp (−αt) is established using a constant α by referring to the Lambert-Beer law.

Here, if α is represented by R, T, and t, and t=700 μm, R does not change depending on the sheet thickness, and thus the total visible light transmittance T_{0.7} in terms of 700 μm can be calculated as T_{0.7}=100×T_{0.7/t}/(1−R)\hat{ }(1.4/t−2) [%]. Here, X\hat{ }Y represents X^{Y}.

The surface reflectance may be calculated based on the refractive index or may be actually measured. In addition, in a case where the sheet thickness t is larger than 700 μm, the visible light transmittance may be measured by adjusting the sheet thickness to 700 μm by polishing or etching.

In addition, in a case where the thickness is 700 μm, the haze value of the present glass ceramic before chemical strengthening is preferably 0.5% or less, more preferably 0.4% or less, still more preferably 0.3% or less, particularly preferably 0.2% or less, and most preferably 0.15% or less. The haze value is preferably as small as possible, but is usually or more. In a case where the thickness is 700 μm, the haze value of 0.02% is equivalent to that of ordinary amorphous glass.

In a case where the total visible light transmittance of the glass ceramic having the thickness t [μm] is 100×T [%] and the haze value is 100×H [%], dH/dt ∝exp (−αt)×(1−H) is established using the above constant α by referring to the Lambert-Beer law.

That is, since it may be considered that the haze value increases in proportion to an internal linear transmittance as the sheet thickness increases, the haze value H_{0.7} in the case of 700 μm is obtained by the following formula. Here, X\hat{ }Y represents X^{Y}.

H_{0.7}=100×[1−(1−H)\hat{ }{((1−R)²−T_{0.7})/((1−R)²−T}][%]

In addition, in a case where the sheet thickness t is larger than 700 μm, the haze value may be measured by adjusting the sheet thickness to 700 μm by polishing or etching.

The present glass ceramic has a high fracture toughness value, and a severe fracture is less likely to occur even when a large compressive stress is formed by chemical strengthening. In a case where the fracture toughness value of the present glass ceramic is preferably 0.81 MPa·m^{1/2} or more, more preferably 0.84 MPa·m^{1/2} or more, and still more preferably 0.87 MPa·m^{1/2} or more, glass having high impact resistance is obtained. An upper limit of the fracture toughness value of the present glass ceramic is not particularly limited, but is typically 1.5 MPa·m^{1/2} or less.

In order to reduce warpage during chemical strengthening treatment, a Young's modulus of the present glass ceramic is preferably 80 GPa or more, more preferably 85 GPa or more, still more preferably 90 GPa or more, and particularly preferably 95 GPa or more. The present glass ceramic may be used after being polished. For ease of polishing, the Young's modulus is preferably 130 GPa or less, more preferably 120 GPa or less, and still more preferably 110 GPa or less.

The present glass ceramic is obtained by subjecting amorphous glass to be described later to heat treatment to crystallize the amorphous glass.

<<Composition of Glass Ceramic>>

The present glass ceramic preferably contains SiO₂, Li₂O, and Al₂O₃. The present glass ceramic more preferably contains, in terms of mol % based on oxides,
40% to 70% of SiO₂,
5% to 35% of Li₂O, and
1% to 20% of Al₂O₃.

In addition, the present glass ceramic further preferably contains, in terms of mol % based on oxides,
50% to 70% of SiO₂,
10% to 30% of Li₂O,
1% to 15% of Al₂O₃,
0% to 5% of P₂O₅,
0% to 8% of ZrO₂,
0% to 10% of MgO,
0% to 5% of Y₂O₃,
0% to 10% of B₂O₃,
0% to 5% of Na₂O,
0% to 5% of K₂O, and
0% to 2% of SnO₂.

In addition, a total amount of SiO₂, Al₂O₃, P₂O₅, and B₂O₃ of the present glass ceramic is preferably 60% to 80% in terms of mol % based on oxides. SiO₂, Al₂O₃, P₂O₅, and B₂O₃ are network forming components of the glass (hereinafter abbreviated as NWF). In a case where the total amount of NWF is large, the strength of the glass is increased. Accordingly, the fracture toughness value of the glass ceramic is increased, and thus the total amount of NWF is preferably 60% or more, more preferably 63% or more, and particularly preferably 65% or more. However, glass in which NWF is extremely large has a high melting temperature or the like, and thus is difficult to be produced. Therefore, the total amount of NWF is preferably 85% or less, more preferably 80% or less, and still more preferably 75% or less.

In the present glass ceramic, a ratio of a total amount of Li₂O, Na₂O, and K₂O to NWF, that is, the total amount of SiO₂, Al₂O₃, P₂O₅, and B₂O₃ is preferably 0.20 to 0.60.

Li₂O, Na₂O, and K₂O are network modifying components, and reducing the ratio to NWF increases gaps in a network, thereby improving the impact resistance. Therefore, the NWF is preferably 0.60 or less, more preferably 0.55 or less, and particularly preferably 0.50 or less. On the other hand, the components are necessary for chemical strengthening, and thus in order to improve the chemical strengthening properties, NWF is preferably 0.20 or more, more preferably 0.25 or more, and particularly preferably 0.30 or more.

The composition of the present glass ceramic will be described below.

In the present glass ceramic, SiO₂ is a component forming a network structure of the glass. In addition, it is also a component that lowers the etching rate of the residual glass. A content of SiO₂ is preferably 40% or more. The content of SiO₂ is more preferably 48% or more, still more preferably 50% or more, particularly preferably 52% or more, and extremely preferably 54% or more. On the other hand, in order to improve the meltability, the content of SiO₂ is preferably 70% or less, more preferably 68% or less, still more preferably 66% or less, and particularly preferably 64% or less.

Li₂O is a component that forms a surface compressive stress by ion exchange, and is a component of the main crystal, and thus is essential. A content of Li₂O is preferably 5% or more, more preferably 10% or more, more preferably 15% or more, still more preferably 18% or more, particularly preferably 20% or more, and most preferably 22% or more. On the other hand, in order to stabilize the glass, the content of Li₂O is preferably 35% or less, more preferably 32% or less, still more preferably 30% or less, particularly preferably 28% or less, and most preferably 26% or less.

Al₂O₃ is a component that increases the surface compressive stress due to chemical strengthening and decreases the etching rate of the residual glass, and thus is essential. A content of Al₂O₃ is preferably 1% or more, more preferably 2% or more, in the following order, still more preferably 3% or more, 5% or more, 5.5% or more, 6% or more, particularly preferably 6.5% or more, and most preferably 7% or more. On the other hand, in order to prevent a devitrification temperature of the glass from being excessively high, the content of Al₂O₃ is preferably 20% or less, more preferably 15% or less, still more preferably 12% or less, particularly preferably 10% or less, and most preferably 9% or less.

P₂O₅ is not essential, but is a component of a Li₃PO₄ crystal, and thus is essential for obtaining glass ceramic containing a Li₃PO₄ crystal. In order to promote crystallization, a content of P₂O₅ is preferably 0.5% or more, more preferably 1% or more, still more preferably 1.5% or more, particularly preferably 2% or more, and extremely preferably 2.5% or more. On the other hand, in a case where the content of P₂O₅ is too large, phase separation at the time of melting is likely to occur, and the acid resistance is significantly reduced. Therefore, the content of P₂O₅ is preferably 5% or less, more preferably 4.8% or less, still more preferably 4.5% or less, and particularly preferably 4.2% or less.

ZrO₂ is a component that increases the mechanical strength and decreases the etching rate of the residual glass, and is preferably contained in order to remarkably improve CS. A content of ZrO₂ is preferably 0.5% or more, more preferably 1% or more, still more preferably 1.5% or more, particularly preferably 2% or more, and most preferably 2.5% or more. On the other hand, in order to reduce devitrification during melting, ZrO₂ is preferably 8% or less, more preferably 5% or less, still more preferably 4% or less, yet still more preferably 3.5% or less, and particularly preferably 3% or less. In a case where the content of ZrO₂ is extremely large, the viscosity is reduced caused by an increase in the devitrification temperature. In order to prevent deterioration of moldability due to such a decrease in viscosity, in a case where a molding viscosity is low, the content of ZrO₂ is preferably 5% or less, more preferably 4.5% or less, and still more preferably 3.5% or less.

MgO is a component for stabilizing glass and is also a component for increasing the mechanical strength and the chemical resistance, and thus is preferably contained in a case where the content of Al₂O₃ is relatively small. A content of MgO is preferably 1% or more, more preferably 2% or more, still more preferably 3% or more, and particularly preferably 4% or more. On the other hand, in a case where MgO is added in an excessively large amount, the viscosity of the glass decreases and devitrification or phase separation easily occurs. Therefore, the content of MgO is preferably 10% or less, more preferably 9% or less, further preferably 8% or less, and particularly preferably 7% or less.

Y₂O₃ is a component having an effect of preventing fragments from scattering when the chemically-strengthened glass is broken, and may be contained. A content of Y₂O₃ is preferably 1% or more, more preferably 1.5% or more, still more preferably 2% or more, particularly preferably 2.5% or more, and extremely preferably 3% or more. On the other hand, in order to prevent the devitrification during melting, the content of Y₂O₃ is preferably 5% or less, and more preferably 4% or less.

B₂O₃ is a component that improves chipping resistance and the meltability of the glass for chemical strengthening or the chemically-strengthened glass, and may be contained. In order to improve the meltability, a content of B₂O₃ in a case of being contained is preferably 0.5% or more, more preferably 1% or more, and still more preferably 2% or more. On the other hand, in a case where the content of B₂O₃ is extremely large, striae is generated at the time of melting or phase separation is likely to occur, and the quality of the glass for chemical strengthening is likely to be deteriorated. Therefore, the content of B₂O₃ is preferably 10% or less. The content of B₂O₃ is more preferably 8% or less, still more preferably 6% or less, and particularly preferably 4% or less.

Na₂O is a component that improves the meltability of the glass. Na₂O is not essential, but in a case of being contained, the contents thereof is preferably 0.5% or more, more preferably 1% or more, and particularly preferably 2% or more. In a case where Na₂O is contained in an extremely large amount, crystals such as Li₃PO₄, which are main crystals, are less likely to be precipitated, and the chemical strengthening properties are deteriorated. Therefore, the content of Na₂O is preferably 5% or less, more preferably 4.5% or less, further preferably 4% or less, and particularly preferably 3.5% or less.

Similar to Na₂O, K₂O is a component that lowers the melting temperature of the glass, and may be contained. A content of K₂O in a case of being contained is preferably 0.5% or more, more preferably 1% or more, still more preferably 1.5% or more, and particularly preferably 2% or more. In a case where K₂O is contained in an extremely large amount, in order to prevent the chemical strengthening properties from decreasing or the etching rate of the residual glass from increasing, the content of K₂O is preferably 5% or less, more preferably 4% or less, still more preferably 3.5% or less, particularly preferably 3% or less, and most preferably 2.5% or less.

In order to improve the meltability of the glass raw materials, a total content Na₂O+K₂O of Na₂O and K₂O is preferably 1% or more, and more preferably 2% or more.

In addition, a ratio K₂O/R₂O of the content of K₂O to a total of contents of Li₂O, Na₂O, and K₂O (hereinafter, referred to as R₂O) is preferably 0.2 or less because the chemical strengthening properties may be increased and the etching rate of the residual glass may be decreased. K₂O/R₂O is more preferably 0.15 or less, and still more preferably 0.10 or less.

R₂O is preferably 10% or more, more preferably 15% or more, and still more preferably 20% or more. In addition, R₂O is preferably 29% or less, more preferably 26% or less.

In addition, in order to reduce the etching rate of the residual glass, ZrO₂/R₂O is preferably 0.02 or more, more preferably 0.03 or more, still more preferably 0.04 or more, particularly preferably 0.1 or more, and most preferably 0.15 or more. In order to increase the transparency after crystallization, ZrO₂/R₂O is preferably 0.6 or less, more preferably 0.5 or less, still more preferably 0.4 or less, and particularly preferably 0.3 or less.

SnO₂ has an effect of promoting generation of crystal nucleation, and may be contained. SnO₂ is not essential, but in a case of being contained, the content thereof is preferably 0.5% or more, more preferably 0.7% or more, still more preferably 1% or more, and particularly preferably 1.5% or more. On the other hand, in order to prevent devitrification during melting, the content of SnO₂ is preferably 3% or less, more preferably 2.5% or less, and still more preferably 2% or less.

TiO₂ is a component capable of promoting crystallization, and may be contained. TiO₂ is not essential, but in a case of being contained, the content thereof is preferably 0.2% or more, and more preferably 0.5% or more. On the other hand, in order to prevent devitrification during melting, the content of TiO₂ is preferably 4% or less, more preferably 2% or less, and still more preferably 1% or less.

BaO, SrO, MgO, CaO, and ZnO are components that improve the meltability of the glass and may be contained. In a case where these components are contained, a total of contents of BaO, SrO, MgO, CaO, and ZnO (hereinafter referred to as BaO+SrO+MgO+CaO+ZnO) is preferably 0.5% or more, more preferably 1% or more, still more preferably 1.5% or more, and particularly preferably 2% or more. On the other hand, since the ion exchange rate decreases, BaO+SrO+MgO+CaO+ZnO is preferably 8% or less, more preferably 6% or less, still more preferably 5% or less, and particularly preferably 4% or less.

Among these, BaO, SrO, and ZnO may be contained in order to improve the refractive index of the residual glass to be close to the precipitated crystal phase, thereby improving the light transmittance of the glass ceramic and decreasing the haze value. In this case, a total of contents of BaO, SrO, and ZnO (hereinafter referred to as BaO+SrO+ZnO) is preferably 0.3% or more, more preferably 0.5% or more, still more preferably 0.7% or more, and particularly preferably 1% or more. On the other hand, these components may reduce the ion exchange rate. In order to improve the chemical strengthening properties, BaO+SrO+ZnO is preferably 2.5% or less, more preferably 2% or less, still more preferably 1.7% or less, and particularly preferably 1.5% or less.

La₂O₃, Nb₂O₅, and Ta₂O₅ are components that make fragments less likely to scatter when the chemically-strengthened glass is broken, and may be contained in order to increase the refractive index. A total of contents of La₂O₃, Nb₂O₅ and Ta₂O₅ (hereinafter, La₂O₃+Nb₂O₅+Ta₂O₅) in a case of being contained is preferably 0.5% or more, more preferably 1% or more, still more preferably 1.5% or more, and particularly preferably 2% or more. In addition, in order to make it difficult for glass to devitrify during melting, La₂O₃+Nb₂O₅+Ta₂O₅ is preferably 4% or less, more preferably 3% or less, still more preferably 2% or less, and particularly preferably 1% or less.

In addition, CeO₂ may be contained. CeO₂ may prevent coloration by oxidizing glass. A content of CeO₂ in a case of being contained is preferably 0.03% or more, more preferably 0.05% or more, and still more preferably 0.07% or more. In order to increase the transparency, the content of CeO₂ is preferably 1.5% or less, and more preferably 1.0% or less.

When the present chemically-strengthened glass is colored for use, a coloring component may be added within a range in which the implementation of desired chemical strengthening properties is not inhibited. Examples of the coloring component include Co₃O₄, MnO₂, Fe₂O₃, NiO, CuO, Cr₂O₃, V₂O₅, Bi₂O₃, SeO₂, Er₂O₃, and Nd₂O₃.

A content of the coloring component in total is preferably 1% or less. In a case where it is desired to further increase the visible light transmittance of the glass, these components are preferably not substantially contained.

In addition, SO₃, a chloride, or a fluoride may be appropriately contained as a refining agent or the like at the time of melting the glass. As₂O₃ is preferably not contained. The content of Sb₂O₃ in a case of being contained is preferably 0.3% or less, more preferably or less, and most preferably not contained.

<Method for Producing Chemically-Strengthened Glass>

A method for producing chemically-strengthened glass according to the present invention includes chemically strengthening glass ceramic containing a crystal and residual glass, and washing the glass ceramic. Such a producing method preferably includes chemically strengthening glass ceramic containing a crystal and residual glass, and washing a surface of the glass ceramic using a washing liquid having a pH of 2 to 12 after the chemical strengthening. The glass ceramic is produced by a method in which amorphous glass having the same composition is crystallized by heat treatment.

<<Production of Amorphous Glass>>

Amorphous glass can be produced, for example, by the following method. The production method described below is an example in a case of producing sheet-shaped chemically-strengthened glass.

Glass raw materials are blended so as to obtain glass having a preferable composition, followed by being heated and melted in a glass melting furnace. Thereafter, the molten glass is homogenized by bubbling, stirring, addition of a refining agent, or the like, is formed into a glass sheet having a predetermined thickness by a known forming method, and is slowly cooled. Alternatively, the molten glass may be formed into a block shape, followed by being slowly cooled and cut into a sheet shape.

<<Crystallization Treatment>>

The amorphous glass obtained by the above procedure is subjected to heat treatment to obtain glass ceramic.

The heat treatment may be a two-stage heat treatment in which the temperature is increased from room temperature to a first treatment temperature and held for a certain period of time, and then held at a second treatment temperature higher than the first treatment temperature for a certain period of time. Alternatively, the heat treatment may be a one-stage heat treatment in which the temperature is cooled to room temperature after being held at a specific treatment temperature.

In a case of the two-stage heat treatment, the first treatment temperature is preferably in a temperature range where a crystal nucleation rate becomes higher in the glass composition, and the second treatment temperature is preferably in a temperature range where a crystal growth rate becomes higher in the glass composition. In addition, holding time at the first treatment temperature is preferably long so that a sufficient number of crystal nuclei are generated. By generating a large number of crystal nuclei, the size of each crystal is reduced, and glass ceramic having high transparency is obtained.

In the case of the two-stage treatment, for example, the temperature is held at a first treatment temperature of 450° C. to 700° C. for 1 hour to 6 hours, and then held at a second treatment temperature of 600° C. to 800° C. for 1 hour to 6 hours. In the case of the one-stage treatment, for example, the temperature is held at 500° C. to 800° C. for 1 hour to 6 hours.

The glass ceramic obtained by the above procedure is subjected to grinding and polishing if necessary to form a glass ceramic sheet. In a case where the glass ceramic sheet is cut into a predetermined shape and size or chamfered, it is preferable to perform cutting or chamfering before performing the chemical strengthening treatment because a compressive stress layer is also formed on an end surface by the subsequent chemical strengthening treatment.

<<Chemical Strengthening Treatment>>

The chemical strengthening treatment is a treatment in which by a method such as immersion in a melt of a metal salt (for example, potassium nitrate) containing a metal ion having a large ionic radius (typically, a Na ion or a K ion), the glass is brought into contact with a metal salt, thereby substituting a metal ion having a small ionic radius (typically, a Na ion or a Li ion) in the glass with a metal ion having a large ionic radius (typically, a Na ion or a K ion for a Li ion, and a K ion for a Na ion).

In order to increase the rate of the chemical strengthening treatment, it is preferable to use “Li—Na exchange” in which Li ions in the glass are exchanged with Na ions. In addition, in order to form a large compressive stress by ion exchange, it is preferable to use “Na—K exchange” in which Na ions in the glass are exchanged with K ions.

Examples of the molten salt for performing the chemical strengthening treatment include a nitrate, a sulfate, a carbonate, and a chloride. Among these, examples of the nitrate include lithium nitrate, sodium nitrate, potassium nitrate, cesium nitrate, and silver nitrate. Examples of the sulfate include lithium sulfate, sodium sulfate, potassium sulfate, cesium sulfate, and silver sulfate. Examples of the carbonate include lithium carbonate, sodium carbonate, and potassium carbonate. Examples of the chloride include lithium chloride, sodium chloride, potassium chloride, cesium chloride, and silver chloride. These molten salts may be used alone or in combination of plurality of kinds thereof.

As treatment conditions of the chemical strengthening treatment, time, temperature, and the like can be selected in consideration of the glass composition, the type of the molten salt, and the like. For example, the present glass ceramic is preferably subjected to the chemical strengthening treatment at 450° C. or lower for 1 hour or shorter. Specifically, preferable example includes a treatment of immersion in a molten salt (for example, a mixed salt of lithium nitrate and sodium nitrate) containing 0.3 mass % of Li and 99.7 mass % of Na at 450° C. for about 0.5 hours.

The chemical strengthening treatment may be, for example, two-stage ion exchange as follows. First, the present glass ceramic is preferably immersed in a metal salt preferably containing Na ions (for example, sodium nitrate) of about 350° C. to 500° C. for about 0.1 hours to 10 hours. Accordingly, an ion exchange between Li ions in the glass ceramic and Na ions in the metal salt occurs, and a relatively deep compressive stress layer can be formed.

Next, the present glass ceramic is preferably immersed in a metal salt preferably containing K ions (for example, potassium nitrate) of about 350° C. to 500° C. for about 0.1 hours to 10 hours. Accordingly, a large compressive stress is generated in a portion of the compressive stress layer formed in the previous treatment, for example, within a depth of about 10 μm. According to such two-stage treatment, a stress profile having a large surface compressive stress value is easily obtained.

<<Washing Treatment>>

By subjecting the chemically-strengthened glass obtained by the chemical strengthening treatment to a washing treatment, a plurality of non-through holes are formed in both main surfaces of the chemically-strengthened glass. The washing treatment is performed by immersing the chemically-strengthened glass in a washing liquid. The pH of the washing liquid is, for example, preferably 2 to 12, more preferably 2.5 to 11, and still more preferably 3 to 10. Washing treatment time may be appropriately adjusted in consideration of the pH and the composition of the washing liquid, the etching rate of the glass ceramic, and the like so that the diameter average value, the depth average value, and the total area ratio of the non-through holes to be formed fall within the desired ranges, but is usually preferably 5 minutes to 48 hours, more preferably 10 minutes to 36 hours, and still more preferably 30 minutes to 24 hours.

A temperature of the washing liquid is not particularly limited, and the washing liquid is used at room temperature (15° C.) to 100° C. In a case where the temperature exceeds 100° C., water in the washing liquid may boil, which is inconvenient in washing operation and is not preferable. After washing, drying may be performed. Examples of a drying method include a method of blowing warm air and a method of blowing compressed air.

Examples of the washing liquid include an acidic or alkaline washing liquid. The acidic washing liquid preferably contains an organic acid and an inorganic acid. Examples of the organic acid contained in the acidic washing liquid include organic carboxylic acids such as citric acid and ascorbic acid, and organic phosphonic acid, and citric acid is preferable. Examples of the inorganic acid contained in the acidic washing liquid include hydrochloric acid, sulfuric acid, phosphoric acid, nitric acid, and fluoric acid, and hydrochloric acid is preferable. In addition, in a case where the inorganic acid is used, a salt of these acid may be added together with the inorganic acid in order to prevent the variation in pH. Examples of a preferable combination of an organic acid and an inorganic acid include citric acid and hydrochloric acid.

The alkaline washing liquid contains a base and may contain a surfactant and a chelating agent in addition to the base. Examples of the base contained in the alkaline washing liquid include alkali metal compounds such as alkali metal hydroxides and alkali metal carbonates, amines, and quaternary ammonium hydroxides. The base is preferably an alkali metal hydroxide such as potassium hydroxide or sodium hydroxide. The surfactant is preferably a nonionic surfactant.

### EXAMPLES

Hereinafter, the present invention will be described with reference to examples, but the present invention is not limited thereto.

<Production and Evaluation of Amorphous Glass>

Glass raw materials were blended so as to have a glass composition represented by mol % based on oxides in Table 1, and were weighed so as to obtain 800 g of glass. Next, the mixed glass raw materials were put into a platinum crucible and put into an electric furnace at 1,600° C. to be melt for about 5 hours, followed by defoaming and homogenizing.

The obtained molten glass was poured into a mold, held at a temperature of a glass transition point for 1 hour, and then cooled to room temperature at a rate of 0.5° C./min to obtain a glass block. Table 1 shows results for evaluating the glass transition point, the specific gravity, the Young's modulus, and the fracture toughness value of the amorphous glass using a part of the obtained block.

In the table, R₂O represents a total of contents of Li₂O, Na₂O, and K₂O, and NWF represents a total of contents of SiO₂, Al₂O₃, P₂O₅, and B₂O₃.

(Specific Gravity ρ)

Measurement was performed by Archimedes method.

(Glass Transition Point Tg)

The glass was pulverized using an agate mortar, about 80 mg of the powder was put into a platinum cell, followed by measuring a DSC curve using a differential scanning calorimeter (DSC 3300 SA, manufactured by Bruker Corporation) while heating from room temperature to 1,100° C. at a heating rate of 10/min to obtain the glass transition point Tg.

Alternatively, a thermal expansion curve was obtained at a heating rate of 10° C./min using a thermal expansion meter (TD 5000 SA manufactured by Bruker AXS) based on JIS R1618:2002, and the glass transition point Tg [unit: ° C.] was obtained from the obtained thermal expansion curve.

(Haze Value)

A haze value [%] of a halogen lamp C light source was measured using a haze meter (HZ-V3 manufactured by Suga Test Instruments Co., Ltd.).

(Young's Modulus E)

Measurement was performed by an ultrasonic method.

(Fracture Toughness Value Kc)

Measurement was performed by an IF method in accordance with JIS R1607:2015.

TABLE 1

| | G1 | G2 |
|---|---|---|
| SiO₂ | 61 | 70.9 |
| Al₂O₃ | 5 | 4.2 |
| P₂O₅ | 2 | 0.9 |
| Li₂O | 21 | 21.7 |
| Na₂O | 2 | 0.1 |
| K₂O | 0 | 0.1 |
| MgO | 5 | 0 |
| ZrO₂ | 3 | 2 |
| Y₂O₃ | 1 | 0 |
| SnO₂ | 0 | 0.2 |
| R₂O | 23 | 21.9 |
| NWF | 68 | 76 |
| ρ (g/cm³) | 2.56 | 2.41 |
| Tg (° C.) | 513 | 481 |
| Haze (%) | 0.02 | 0.05 |
| E (GPa) | 90 | 84 |
| Kc (MPa · m^{1/2}) | 0.98 | 1.01 |

<Crystallization Treatment and Evaluation on Glass ceramic>

The obtained glass block was processed into a size of 50 mm×50 mm×1.5 mm, and then subjected to heat treatment under conditions described in Table 2 to obtain glass ceramic. In a column of the crystallization conditions in the table, an upper column indicates nucleation treatment conditions and a lower column indicates crystal growth treatment conditions, and for example, a case where 550° C. 2 h is described in the upper column and 750° C. 2 h is described in the lower column indicates that the temperature was held at 550° C. for 2 hours and then held at 750° C. for 2 hours.

The obtained glass ceramic was processed and mirror-polished to obtain a glass ceramic sheet having a thickness t of 700 μm. In addition, a rod-shaped sample for measuring a thermal expansion coefficient was prepared. A part of the remaining glass ceramic was pulverized and used for analysis of precipitated crystals. Evaluation results of the glass ceramic are shown in Table 2.

(X-Ray Diffraction: Precipitated Crystal)

Powder X-ray diffraction was measured under the following conditions to identify precipitated crystals.
Measurement device: SmartLab manufactured by Rigaku Corporation
X-ray used: CuKα ray
Measurement range: 2θ=10° to 80°
Speed: 1°/min
Step: 0.01°

Detected main crystals are shown in a crystal column of Table 2. Li₃PO₄ and Li₄SiO₄ are difficult to be distinguished by powder X-ray diffraction, and thus are described together.

(Haze Value)

A haze value [%] of a halogen lamp C light source was measured using a haze meter (HZ-V3 manufactured by Suga Test Instruments Co., Ltd.).

TABLE 2

| Glass ceramic | CG1 | CG2 |
|---|---|---|
| Glass | G1 | G2 |
| Heat treatment | 550° C. 2 h | 570° C. 4 h |
| conditions | 750° C. 2 h | 740° C. 1 h |
| Crystal | Li₃PO₄ | LiAlSi₄O₁₀ |
| | Li₄SiO₄ | Li₂Si₂O₅ |
| Haze (%) | 0.03 | 0.18 |

<Chemical Strengthening Treatment and Washing Treatment>

Glass ceramic CG1 and CG2 were chemically strengthened under conditions shown in Table 3 to perform ion exchange treatment, and the obtained chemically-strengthened glass was defined as glass A, glass B, and glass X, respectively. The obtained chemically-strengthened glass was immersed in a washing liquid having a pH of 8.9 at room temperature for 24 hours to perform the washing treatment, and the chemically-strengthened glass of Examples 1 to 4 were obtained and analyzed. Evaluation results of the chemically-strengthened glass are shown in Table 4. In Table 4, Examples 1 and 2 are working examples, and Examples 3 and 4 are comparative examples.

(Stress Profile)

A stress profile was measured by using a scattered light photoelasticity stress meter SLP-2000 manufactured by Orihara Industrial Co., Ltd.

(Etching Rate)

Etching rate was determined by measuring weight loss per hour due to NaOH treatment (95° C., pH: 10).

(Crystallinity and Average Particle Size)

Powder X-ray diffraction was measured under the following conditions, and a crystallinity [unit: %] and an average crystal size (crystal size) [unit: nm] were calculated using the Rietveld method.
Measurement device: SmartLab manufactured by Rigaku Corporation
X-ray used: CuKα ray
Measurement range: 20=10° to 80°
Speed: 10°/min
Step: 0.02°

(Diameter Average Value and Total Area Ratio of Non-Through Holes)

A diameter average value of the non-through holes and a total area ratio of the non-through holes were determined as follows. The chemically-strengthened glass was observed from directly above by SEM to obtain a surface SEM image at a magnification of 100,000 times. From the obtained surface SEM image, the non-through holes and matrix portions were distinguished, a major axis of each non-through hole was determined as the diameter, and an average value thereof was calculated as a diameter average value. In addition, the total area ratio of the non-through holes was determined by a ratio of a total area of the non-through holes to a total visual field area of the surface SEM image.

(Depth Average Value of Non-Through Holes)

In the present description, a depth of the non-through hole was determined as follows. A cross-sectional SEM image at a magnification of 300,000 times was obtained at a fractured surface of the chemically-strengthened glass. In the obtained cross-sectional SEM image, the non-through holes and the matrix portions were distinguished, the depth of each non-through hole was determined, and a depth average value, which is an average value of the depths, was calculated.

(Drop Strength)

In a drop test, the obtained glass sample of 120×60×0.6 mmt was fitted into a structure whose mass and rigidity were adjusted to a size of a general smartphone currently used to prepare a pseudo smartphone, and was freely dropped on #180 SiC sandpaper. A drop height is obtained by repeating an operation that in a case where a glass sample is dropped from a height of 5 cm and is not cracked, raising the height by 5 cm and dropping the sample again until the glass sample is cracked, and measuring an average value of heights of 10 samples at the time of being cracked for the first time.

(Transmittance)

An average transmittance of light having a wavelength of 380 nm to 780 nm was measured as the transmittance.

TABLE 3
Chemically-

| strengthened glass | Glass A | | Glass B | | Glass X | |
|---|---|---|---|---|---|---|
| Glass ceramic | CG1 | | CG1 | | CG2 | |
| First-stage | NaNO₃ | | NaNO₃ 20% + | | NaNO₃ 40% + | |
| strengthening salt | 100% | | KNO₃ 80% | | KNO₃ 60% | |
| First-stage | 390° | C. | 410° | C. | 500° | C. |
| strengthening | | | | | | |
| temperature | | | | | | |
| First-stage | 5.5 | hour | 5 | hour | 8 | hour |
| strengthening time | | | | | | |
| Second-stage | KNO₃ 99.5% + | | KNO₃ 99.5% + | | Absence | |
| strengthening salt | LiNO₃ 0.5% | | LiNO₃ 0.5% | | | |
| Second-stage | 410° | C | 410° | C. | Absence | |
| strengthening | | | | | | |
| temperature | | | | | | |
| Second-stage | 1 | hour | 1 | hour | Absence | |
| strengthening time | | | | | | |

TABLE 4

| | Example | Example | Example | Example |
|---|---|---|---|---|
| | 1 | 2 | 3 | 4 |
| Chemically- | Glass A | Glass B | Glass A | Glass X |
| strengthened glass | | | | |
| t [μm] | 700 | 700 | 700 | 700 |
| CS₀ [MPa] | 540 | 530 | 540 | 340 |
| CS₅₀ [MPa] | 220 | 240 | 220 | 100 |
| CS_{t/2} [MPa] | −100 | −105 | −100 | −110 |
| DOL [μm] | 90 | 128 | 90 | 180 |
| Ec [nm/min] | 1 | 1 | 1 | 0.01 |
| Eg/Ec | 0.007 | 0.008 | 0.007 | 1.5 |
| Crystallinity [%] | 20 | 20 | 20 | 88 |
| Average crystal size | 15 | 15 | 15 | 35 |
| [nm] | | | | |
| Washing treatment | Presence | Presence | Absence | Absence |
| Diameter average value | 25 | 22 | 0 | 0 |
| of non-through hole [nm] | | | | |
| Total area ratio of non- | 5.3 | 4.1 | 0 | 0 |
| through hole [%] | | | | |
| Depth average value of | 22.00 | 25.00 | 0 | 0 |
| non-through hole [nm] | | | | |
| Drop strength [cm] | 180 | 190 | 180 | 130 |
| Transmittance [%] | 92.5 | 92.4 | 91.1 | 90.2 |

As shown in Table 4, Examples 1 and 2, which are the chemically-strengthened glasses according to the present invention, are superior in transparency and strength to Examples 3 and 4, which are comparative examples.

Although the present invention has been described in detail with reference to specific embodiments, it is apparent to those skilled in the art that various changes and modifications can be made without departing from the spirit and scope of the present invention. The present application is based on a Japanese Patent Application (No. 2021-065435) filed on Apr. 7, 2021, the contents of which are incorporated herein by reference.

### REFERENCE SIGNS LIST

24 chemically-strengthened glass
22 non-through hole

What is claimed is:

1. A chemically-strengthened glass having a first main surface and a second main surface facing each other, wherein
the chemically-strengthened glass comprises a glass ceramic comprising a crystal and a residual glass,
the chemically-strengthened glass has a surface compressive stress value (CS₀) of 450 MPa or more, and a compressive stress value (CS₅₀) at a depth of 50 μm from a surface of the chemically-strengthened glass of 150 MPa or more,
the chemically-strengthened glass has a plurality of non-through holes having a diameter average value of 5 nm to 50 nm on the first main surface and the second main surface,
the non-through holes have a depth average value measured by a cross-sectional SEM image of the first main surface and the second main surface of 5 nm to 50 nm, and
the non-through holes have a total area ratio to a total visual field area of a surface SEM image of the first main surface and the second main surface of 1% to 40%.

2. The chemically-strengthened glass according to claim 1, wherein the glass ceramic has Eg/Ec of 0.1 to 0.0001, provided that Eg is an etching rate of the residual glass and Ec is an etching rate of the crystal.

3. The chemically-strengthened glass according to claim 1, having a base composition comprising 40% to 70% of SiO₂, 5% to 35% of Li₂O, and 1% to 20% of Al₂O₃ in terms of mol % based on oxides.

4. The chemically-strengthened glass according to claim 1, having a crystallization rate of 10 mass % to 90 mass %.

5. The chemically-strengthened glass according to claim 1, wherein the first main surface and the second main surface have a reflectance of 10% or less.

6. The chemically-strengthened glass according to claim 1, having a light transmittance in terms of a thickness of 700 μm before chemical strengthening of 90% or more.

7. The chemically-strengthened glass according to claim 1, having a sheet thickness of 300 μm to 3,000 μm.

8. A method for producing a chemically-strengthened glass, the method comprising:
chemically strengthening a glass ceramic comprising a crystal and a residual glass to obtain a chemically-strengthened glass; and
washing a surface of the chemically-strengthened glass using a washing liquid having a pH of 2 to 12 after the chemical strengthening,
wherein
the chemically-strengthened glass has a first main surface and a second main surface facing each other,
the chemically-strengthened glass has a surface compressive stress value (CS₀) of 450 MPa or more, and a compressive stress value (CS₅₀) at a depth of 50 μm from a surface of the chemically-strengthened glass of 150 MPa or more,
the chemically-strengthened glass has a plurality of non-through holes having a diameter average value of 5 nm to 50 nm on the first main surface and the second main surface,
the non-through holes have a depth average value measured by a cross-sectional SEM image of the first main surface and the second main surface of 5 nm to 50 nm, and
the non-through holes have a total area ratio to a total visual field area of a surface SEM image of the first main surface and the second main surface of 1% to 40%.

9. The method for producing a chemically-strengthened glass according to claim 8, wherein Eg/Ec is 0.1 to 0.0001, provided that Eg is an etching rate of the residual glass and Ec is an etching rate of the crystal.

10. The method for producing a chemically-strengthened glass according to claim 8, wherein the glass ceramic has a base composition comprising 40% to 70% of SiO₂, 5% to 35% of Li₂O, and 1% to 20% of Al₂O₃ in terms of mol % based on oxides.
